(19) United States
(12) Patent Application Publication
(10) Pub. No.: US 2014/0149923 A1
(43) Pub. Date: May 29, 2014

(54) INFORMATION PROCESSING APPARATUS, DISPLAY APPARATUS, METHOD FOR CONTROLLING INFORMATION PROCESSING APPARATUS, AND PROGRAM

(71) Applicant: CANON KABUSHIKI KAISHA, Tokyo (JP)

(72) Inventor: Yoshiteru Horiike, Yokohama-shi (JP)

(73) Assignee: CANON KABUSHIKI KAISHA, Tokyo (JP)

(21) Appl. No.: 14/085,624

(22) Filed: Nov. 20, 2013

(30) Foreign Application Priority Data
Nov. 26, 2012 (JP) 2012-257556

(51) Int. Cl. G06F 3/0485

(52) U.S. Cl. CPC G06F 3/0485
USPC 715/784

(57) ABSTRACT

An information processing apparatus cyclically scrolls contents displayed on a predetermined display area when a user operation on a touch panel for scrolling a part of contents displayed on the display area is detected among a plurality of contents. The scrolling is stopped or decelerated when the boundary of the plurality of contents has been scrolled up to an end of the display area.

### BACKGROUND OF THE INVENTION

1. Field of the Invention

The present disclosure relates to an information processing apparatus, a display apparatus, and a method for controlling an information processing apparatus, and a program, which are configured to cyclically display a plurality of contents by scrolling.

2. Description of the Related Art

In recent years, touch panel computers have been generally used. When using such a computer, a user displays a part of contents of a list such as an address book on a screen and performs a flick operation on the screen to scroll the contents list (Japanese Patent Application Laid-Open No. 2010-103919).

When an amount of contents enormously increases, if a user is going to display the top content again after scrolling down from the top to the end of the contents list, it takes much time in scrolling.

As a solution for addressing such a problem, there is a known method for cyclically scrolling a list of contents. More specifically, when the end contents are reached by scrolling down to the end of the list, the top content is subsequently displayed. In contrast, when the top content is reached by scrolling up to the top of the list, the end content is subsequently displayed.

However, even though the cyclic scrolling can conveniently shorten a time for returning from the end to the top of a list, a boundary between the top and the end is elusive. In some cases, the cyclic scrolling takes more time for a user to reach the target contents.

### SUMMARY OF THE INVENTION

The present invention is directed to an information processing apparatus, a display apparatus, a method for controlling an information processing apparatus, and a program, which enable a user to easily recognize a boundary of a plurality of contents even when the user displays the contents by cyclic scrolling.

According to an aspect of the present invention, an information processing apparatus of the present invention includes: a display unit configured to display a part of a plurality of contents on a predetermined display area; a detection unit configured to detect an user operation on a touch panel for scrolling the contents displayed on the display area; a display control unit configured to cyclically scroll the contents displayed on the display area in response to the detection by the detection unit, wherein the display control unit controls the scrolling to enable a user to recognize a boundary of the plurality of contents when the boundary of the plurality of contents has been scrolled up to a border of the display area.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an exemplary hardware configuration of an information processing apparatus according to an exemplary embodiment of the present invention.

FIG. 2 is a diagram illustrating an exemplary screen displayed in an information processing apparatus according to a first exemplary embodiment.

FIG. 3A and FIG. 3B are diagrams illustrating screens displayed in the information processing apparatus according to the first exemplary embodiment.

FIG. 4A and FIG. 3B are diagrams illustrating screens displayed in the information processing apparatus according to the first exemplary embodiment.

FIG. 5 is a diagram illustrating an operation method for instructing scrolling in the first exemplary embodiment.

FIG. 6 is a flow chart illustrating an operation of the information processing apparatus according to the first exemplary embodiment.

FIG. 7A and FIG. 7B are diagrams illustrating screens displayed in the information processing apparatus according to a second exemplary embodiment.

FIG. 8 is a flow chart illustrating an operation of the information processing apparatus according to the second exemplary embodiment.

FIG. 9 is a flow chart illustrating an operation of the information processing apparatus according to a third exemplary embodiment.

### DESCRIPTION OF THE EMBODIMENTS

Various exemplary embodiments, features, and aspects of the invention will be described in detail below with reference to the drawings.

<Hardware Configuration>

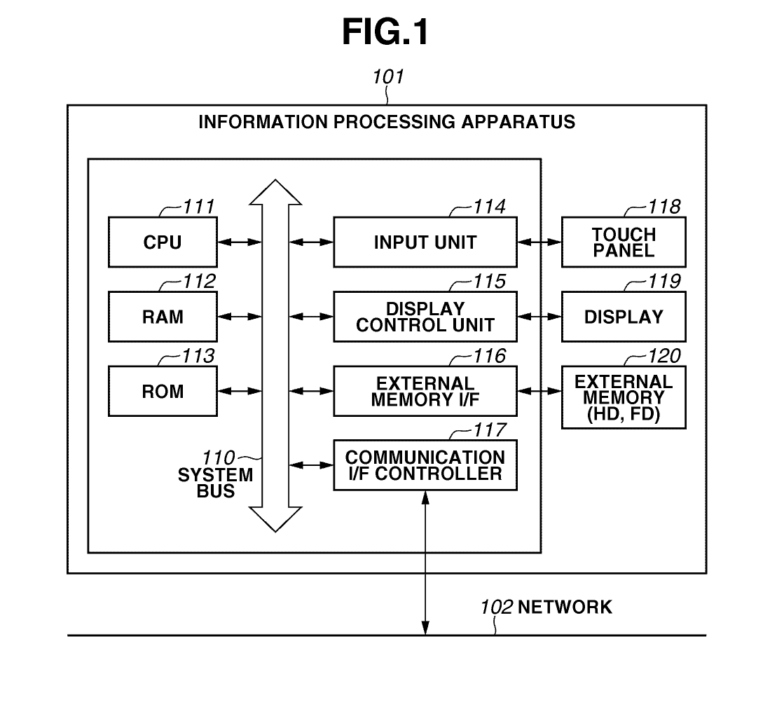

FIG. 1 is a diagram illustrating a hardware configuration of an information processing apparatus 101 to which the present invention is applicable.

In FIG. 1, a central processing unit (CPU) 111, a random-access memory (RAM) 112, a read-only memory (ROM) 113, an input unit 114, a display control unit 115, an external memory interface (I/F) 116, and a communication interface (I/F) controller 117 are connected to a system bus 110. Further, a touch panel 118, a display 119, and an external memory 120 are connected to a system bus 110. The units connected to the system bus 110 are configured to exchange data with one another through the system bus 110.

The ROM 113 is a non-volatile memory that stores image and other data and various programs for operating the CPU 111 in their respective predetermined regions. The RAM 112 is a volatile memory and used as a main memory and a temporary memory area such as a work area of the CPU 111. The CPU 111 controls each part of the information processing apparatus 101 using, for example, the RAM 112 as a work memory based on the programs stored in the ROM 113. The programs for operating the CPU 111 are not limited to those stored in the ROM 113. The programs may be previously stored in the external memory (e.g., a hard disk) 120

The input unit 114 accepts a user operation, generates a control signal in response to the operation, and supplies the signal to the CPU 111. The input unit 144 includes, as devices for accepting a user operation, for example, a character information input device such as a keyboard (not shown), a mouse (not shown), and a pointing device such as a touch panel 118. The touch panel 118 is an input device configured to output coordinate information corresponding to a position at which a user touches a flat input unit, for example. The CPU 111 respectively controls the units of the information processing apparatus 101 based on programs in response to a control signal generated and supplied from the input unit 114 corresponding to a user operation on the input device. Thus, the information processing apparatus 101 can operate in response to the user operation.

The display control unit 115 outputs a display signal for displaying an image on the display 119. For example, the CPU 111 generates a display control signal based on a program and then supplies the signal to the display control unit 115. Subsequently, the display control unit 115 generates a display signal in response to the display control signal, and then outputs the display signal to the display 119. For example, the display control unit 115 causes the display 119 to display a graphical user interface (GUI) screen.

The touch panel 118 is integrated with the display 119. For example, the touch panel 118 is configured not to suppress any display on the display 119 due to the light transmittance. The touch panel 118 is attached on an upper layer of the display screen of the display 119. Input coordinates of the touch panel 118 are associated with the display coordinates on the display 119. Thus, the touch panel 118 can provide a GUI that allows a user to feel like directly operating a screen on the display 119.

The external memory I/F 116 can connect to the external memory 120 such as a hard disk, a flexible disk, a compact disc (CD), a digital versatile disc (DVD), or a memory card. Under control of the CPU 111, the external memory I/F 116 reads data from the connected external memory 120 and writes data to the connected external memory 120. The communication I/F controller 117 communicates with a various kind of a network 102, such as a local area network (LAN), the Internet, a wired network, or a wireless network under control of the CPU 111.

The CPU 111 can detect, for example, the following states or operations on the touch panel 118: a state where the user has touched the touch panel with his or her finger or a pen (hereinafter, referred to as “touch down”); a state where the user is touching the touch panel with his or her finger or the pen (hereinafter, referred to as “touch on”); a state where the user moves his or her finger or the pen while touching the panel (hereinafter, referred to as “move”); a state where the user has removed his or her finger or the pen from the touch panel (hereinafter, referred to as “touch up”); and a state where the touch panel is not touched by anything (hereinafter, referred to as “touch off”).

These operations, and the position coordinates touched by the finger or pen on the touch panel are informed to the CPU 111 through the system bus 110. Based on the notified information, the CPU 111 determines what kind of an operation has been performed on the touch panel. As for the “move”, a direction along which the finger or pen moves on the touch panel can be determined from changes in position coordinates with respect to each of vertical component and horizontal component on the touch panel.

The term “flick” used herein refers to a quick stroke that corresponds to operations from “touch down” to “touch up” that passes through certain “move”. In the flicking the finger touching the touch panel is quickly moved for a certain distance and the finger is removed from the touch panel. In other words, the flicking is an operation of quickly tracing a line on the touch panel with the finger. The CPU 111 determines that the flicking has been performed when “touch up” is detected directly after detecting “move” which is performed at a predetermined speed or more and over a predetermined distance or more.

The CPU 111 determines that the dragging has been performed when “touch on” is detected after detecting “move” over a predetermined distance or more. The touch panel 118 may be of any type such as a resistance film type, electrostatic capacitance type, surface acoustic wave type, infrared type, electromagnetic induction type, image recognition type, or optical sensor type.

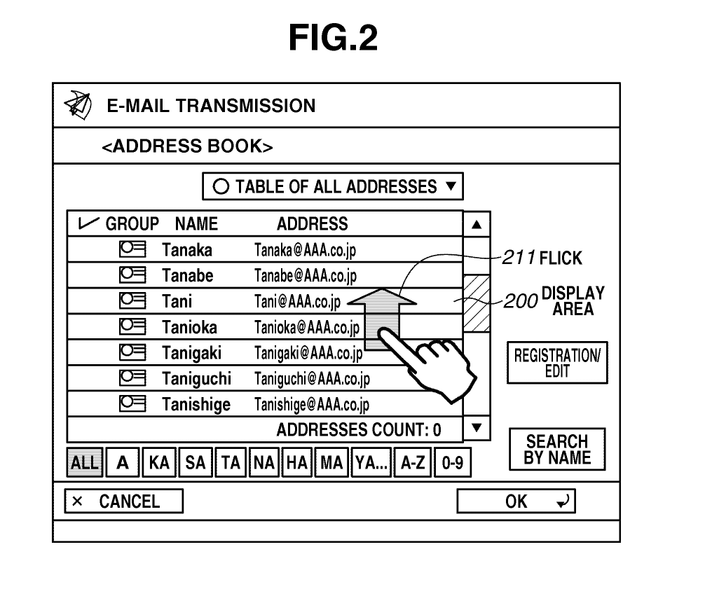

FIG. 2 to FIGS. 4A and 4B are diagrams each illustrating a screen displayed on the display 119 of the information processing apparatus 101 according to the first embodiment.

FIG. 2 is a screen for selecting an address used for e-mail transmission when a user employs an e-mail transmission function, which is one of data transmission functions of the information processing apparatus 101. The data of an address book is stored in the external memory 120 of the information processing apparatus 101.

As illustrated in FIG. 2, if the address book includes a large number of addresses, a display area 200 for the address book of the display 119 cannot cover all the address data. Thus, the user has to scroll a partially displayed list of addresses to display desired address data on the display area 200.

FIG. 2 illustrates an exemplary flick operation performed by the user on an arbitrary portion of an area where the address data is displayed on the display 119 (the arrow 211 in the figure represents a flick with the finger). If the user flicks the finger upward, the displayed address data list scrolls upward.

According to the present exemplary embodiment, the display of the address book is cyclically scrolled. For example, when scrolling down, the end data, an address of “WATARI”, is displayed next to the top data, an address of “AIZAWA”. When scrolling up, the top data, the address of “AIZAWA”, is displayed next to the end data, the address of “WATARI”.

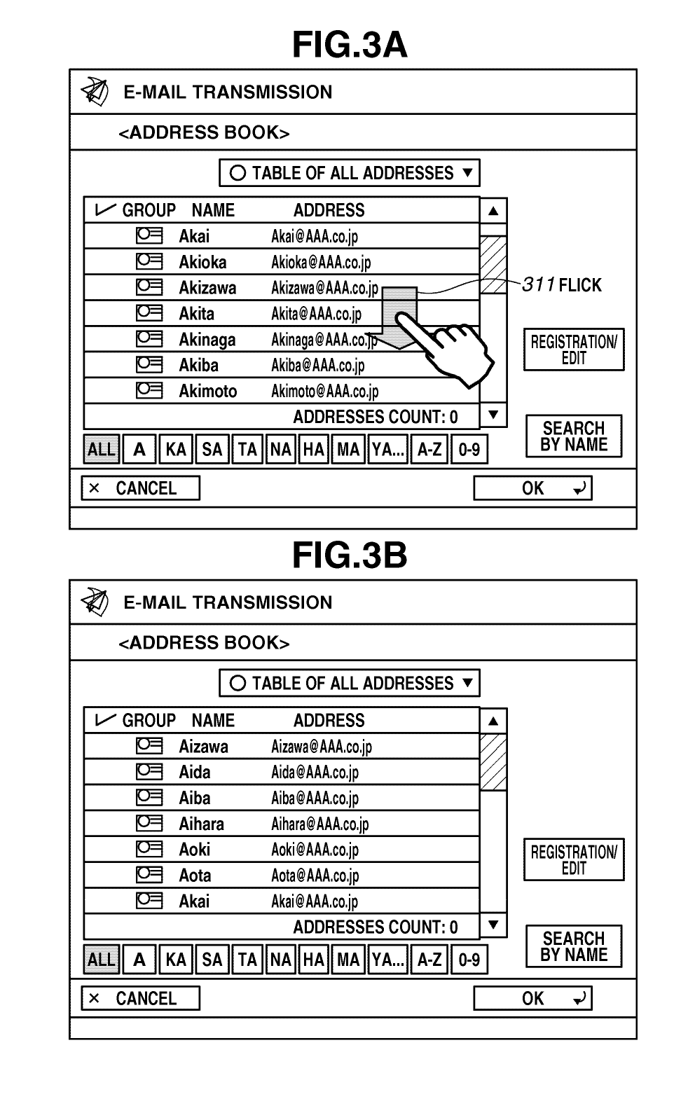

FIG. 3A and FIG. 3B are diagrams each illustrating the flow of a downward flick operation performed by the user. First, as illustrated in FIG. 3A, in a state that data in the first half of an address book is list-displayed, the user performs a downward flick operation (311) to scroll the address book. Subsequently, as illustrated in FIG. 3B, the scrolling is suspended upon display of the top data of the address data, the address of “AIZAWA”, on the upper end of an address display area. Thus, the address book is not scrolled to the end data.

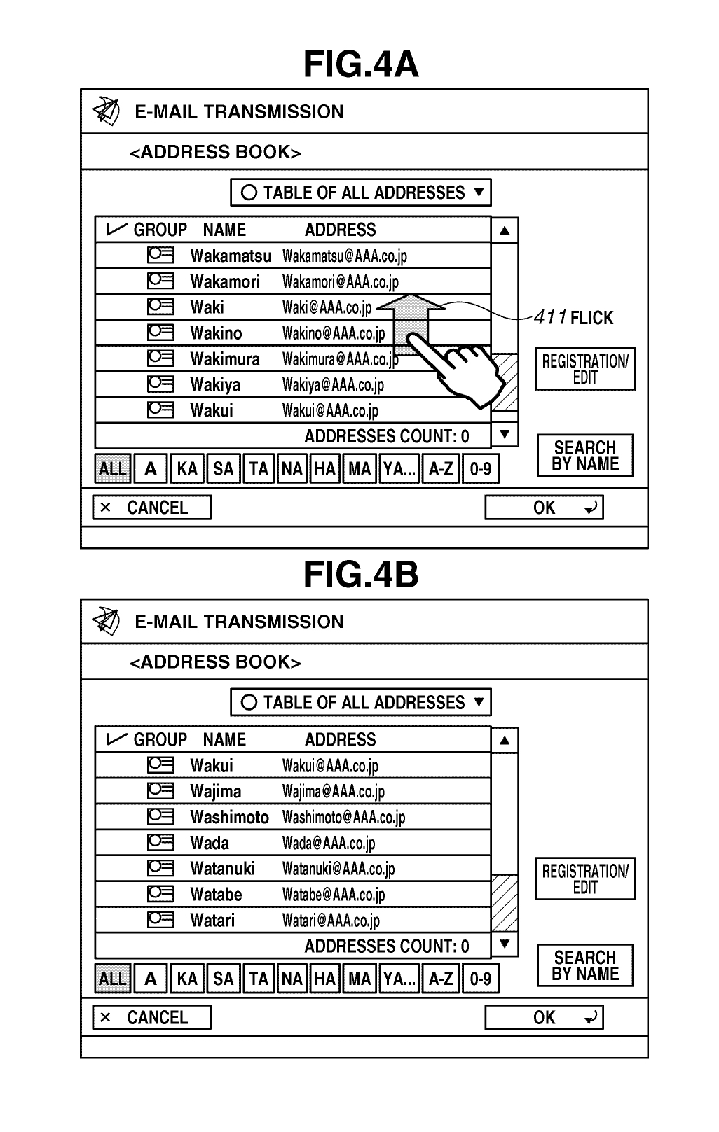

FIG. 4A and FIG. 4B are diagrams each illustrating the flow of an upward flick operation performed by the user. First, as illustrated in FIG. 4A, in a state that data in the latter half of an address book is displayed in list form, the user performs an upward flick operation (411) to scroll the address book. Subsequently, as illustrated in FIG. 4B, the scrolling is suspended upon display of the end data of the address data, the address of “WATARI”, on the lower end of an address display area. Thus, the address book is not scrolled to the top data.

Therefore, in the case where the address book is displayed by cyclic scrolling, according to the present exemplary embodiment, the scrolling is stopped at the boundary between the top and the end of the address book in the scrolling with flick.

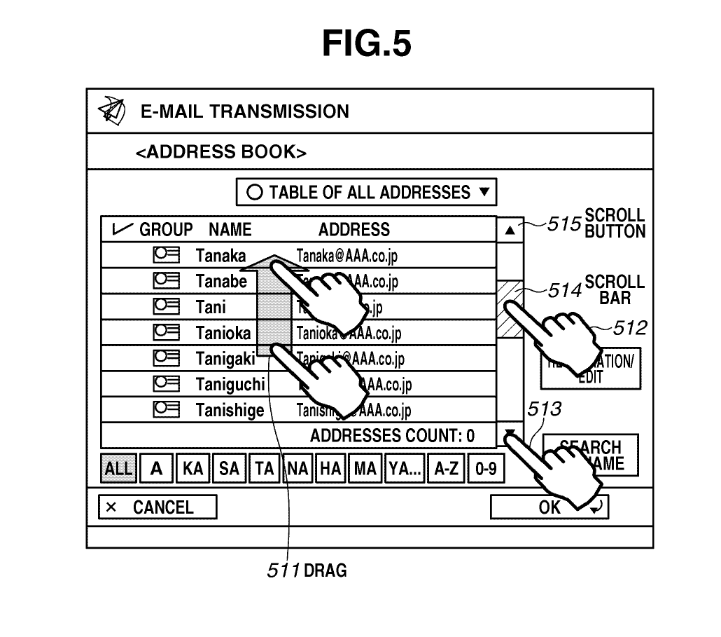

FIG. 5 is a diagram illustrating an operation for scrolling the list of addresses other than the flick operation in the present exemplary embodiment. The present exemplary embodiment includes following three operation methods for scrolling the list of address data in addition to the flick operation. However, the operation method for scrolling is not limited to these four methods including the flick operation.

In a first operation method other than the flick, a user drags (511) an arbitrary portion of an area where the list of addresses is displayed on the display 119. In this method, the list of addresses is scrolled by an amount equivalent to a movement made by a user from a “touch down” portion to a “touch up” portion (moving distance).

A second operation method is scrolling using a scroll bar (514) displayed on the display 119. Specifically, the user performs “touch down” on a portion displaying the scroll bar (514) on the display 119, and then drags (512) it while keeping the state of “touch on”. In this method, the list of addresses can be scrolled by an amount equivalent to the moving distance of the scroll bar (514).

In a third operation method, a user pushes down a scroll button (515) displayed on the display 119. Specifically, the user performs “touch down” on a portion displaying the scroll button (515) (upper or lower arrow button) on the display 119, and then holds the state of “touch on” (513). In this method, the list of address can be scrolled by an amount equivalent to the duration of “touch on” on the scroll button (515).

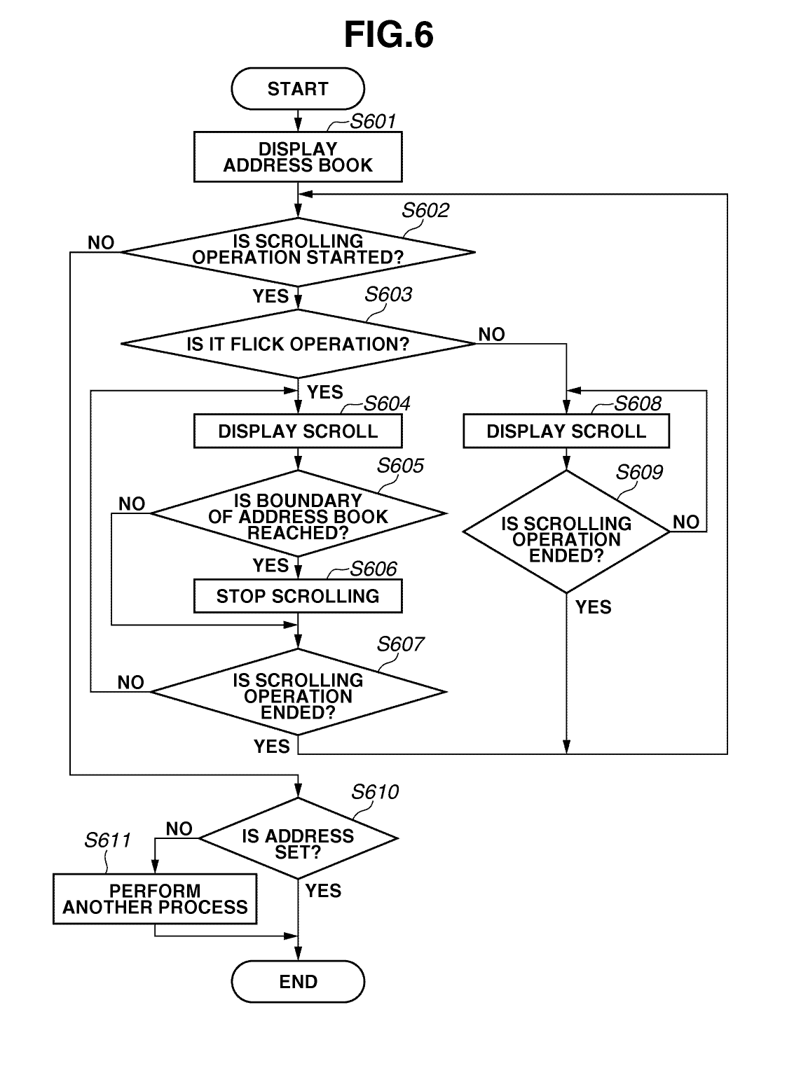

Next, the operation of the information processing apparatus 101 according to the present exemplary embodiment will be described with reference to FIG. 6. FIG. 6 is a flow chart carried out when the address book illustrated in FIG. 2 is displayed on the display 119 in the information processing apparatus 101 according to the present exemplary embodiment. Each step in FIG. 6 is processed when the CPU 111 executes a program stored in the ROM 113 or the external memory 120.

First, in step S601, the CPU 111 and the control unit 115 cause the display 119 to display, in a list form, address data included in the address book, in response to a predetermined operation of a user. If there is a large number of the address data, the display area (200) cannot cover all the data. Thus, the display 119 displays only some of data in the list form.

In step S602, the CPU 111 determines whether a scrolling operation is started. Specifically, the CPU 111 employs any one of the above operation methods for carrying out scrolling to determine whether the list of addresses is scrolled. As a result of the determination in step S602, if the CPU 111 determines that the scrolling operation is started (YES in step S602), then the CPU 111 advances the process to step S603 to determine whether the started scrolling operation is caused by a flick operation.

In step S603, if the CPU 111 determines that it is caused by the flick operation (YES in step S603), then the CPU 111 advances the process to step S604. On the other hand, if the CPU 111 determines that it is caused by an operation other than the flick operation (NO in step S603), such as a drag operation, the CPU 111 advances the process to step S608.

In step S604, the CPU 111 scrolls and displays the list of addresses. In step S605, the CPU 111 determines whether the boundary between the top and the end of the address book reaches the end of the display area 200 by scrolling. More specifically, if the user scrolls the list downward, the CPU 111 determines whether the top data is displayed on the first line of the display area. If the user scrolls the list upward, the CPU 111 determines whether the end data is displayed on the last line of the display area. In other words, the CPU 111 determines whether the user scrolls the list to the top data or end data of the address book.

As a result of the determination in step S605, if the CPU 111 determines that the boundary of the address book reaches the end of the display area 200 by the scrolling (YES in step S605), then the CPU 111 advances the process to step S606 and subsequently stops the scrolling. In this case, the display 119 displays a screen as illustrated in FIG. 3B or FIG. 4B. If the CPU 111 determines that the boundary of the address book does not reach the end of the display area 200 by scrolling (NO in step S605), then the CPU 111 advances the process to step S607.

In step S607, the CPU 111 determines whether the scrolling operation is completed. Specifically, the CPU 111 determines whether the scrolling operation for a certain period is completed and the scrolling of the address list is stopped. If the CPU 111 determines that the scrolling operation is completed (YES in step S607), then the CPU 111 advances the process to step S602. If the CPU 111 determines that the scrolling operation is not completed (NO in step S607), then the CPU 111 returns the process to step S604. If the scrolling is stopped in step S606, then the CPU 111 determines that the scrolling operation is completed. Then, the CPU 111 waits for the next user operation (step S602).

After that, if the user starts the scrolling operation again, scrolling is stared from the state of FIG. 3B or FIG. 4B. For example, if the user flicks the list downward from the state of FIG. 3B, the CPU 111 cyclically scrolls and displays the list toward the data on the end side. If the user flicks the list upward from the state of FIG. 4B, the CPU 111 cyclically scrolls and displays the list toward the data on the top side. More specifically, even in the case that the scrolling is once stopped at the boundary between the top and the end of the list, the re-scrolling operation can cause scrolling and display of the list over the boundary.

On the other hand, if the scrolling is not stopped in step S606, or the scrolling does not reach the top or end of the address book (NO in step S605), then the CPU 111 continues the scrolling until the user ends the flick operation for scrolling.

In step S603, if the CPU 111 determines that the scrolling is not caused by the flick operation (NO in step S603), then the CPU 111 advances the process to step S608 to cause the display 119 to display scrolling of the list of addresses until the scrolling operation is completed in the subsequent step S609. That is, if the user scrolls the list of addresses by a method other than the flick operation, such as a drag operation, the CPU 111 does not stop the scrolling at the boundary between the top and the end of the address book.

In the flick operation, compared with other operations, the user has a difficulty in adjusting a scrolling speed to a desired speed. On the other hand, for example, the user operation and the scroll speed are synchronized in the drug operation. Thus, a user intentionally can adjust the scroll rate in a comparatively easy manner, so that it is less likely that the user may overlook a desired address. In the present embodiment, in consideration of such a difference in operability, the CPU 111 distinguishes the flick operation from other operations.

In step S602, if the CPU 111 does not determine that the scrolling operation is started (YES in step S602), then the CPU 111 advances the process to step S610. In step S610, the CPU 111 determines whether an address of e-mail transmission is set. More specifically, the CPU 111 determines whether the user has pushed an “OK” button in the state that an arbitrary address is selected in the address list screen illustrated in FIG. 2. In step S610, if the CPU 111 determines that the address of e-mail transmission is set (YES in step S610), then the CPU 111 completes the display of the address book. On the other hand, if the CPU 111 determines that the address of e-mail transmission is not set in S610 (NO in step S610), then the CPU 111 advances the process to step S611. Subsequently, the CPU 111 completes the display of the address book after performing any other optional processes.

The information processing apparatus according to the present exemplary embodiment stops scrolling at the boundary between the top and the end of the address book when the user performs a flick operation in the cyclic scrolling. Thus, the user does not overlook a desired address during the scrolling due to difficulty in finding the boundary between the top and the end of the address book. In addition, even after the scrolling is once stopped, the scrolling can be performed over the boundary when the user performs a flick operation. Thus, the above effects can be attained while the merits of the cyclic scrolling display are retained.

Next, a second exemplary embodiment will be described. In the second embodiment, when the boundary between the top and the end of the address book is displayed on the display area of the display 119 at the time of starting a scrolling operation, the CPU 111 does not stop scrolling at the boundary between the top and the end of the address book whether or not a flick operation causes the scrolling. Hereinafter, the second exemplary embodiment will be described focusing on differences between the first and second exemplary embodiments.

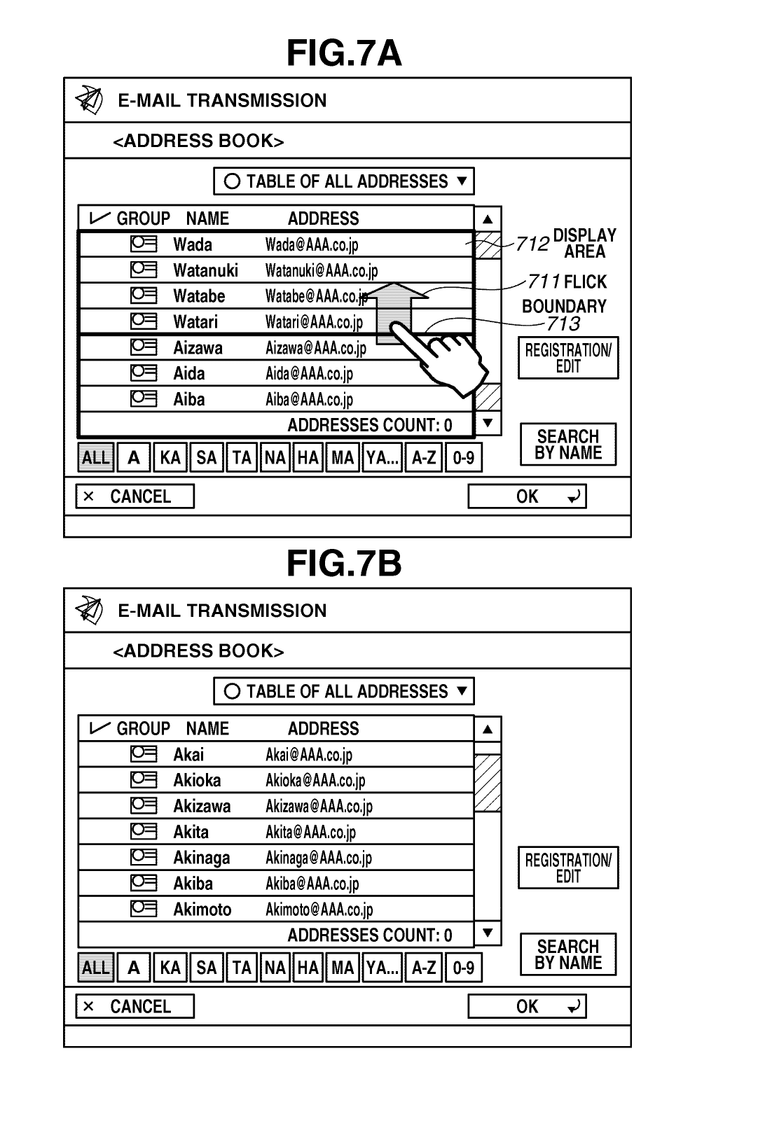

FIG. 7A and FIG. 7B are diagrams each illustrating a screen displayed on the display 119 of the information processing apparatus 101 according to the second embodiment. FIG. 7A and FIG. 7B illustrate a flow when a user performs an upward flick operation. As illustrated in FIG. 7A, the user performs the upward flick operation (711) in a state that the boundary (713) between the top and the end of an address book is displayed on a display region 712. In this case, as illustrated in FIG. 7B, the scrolling is not stopped at the boundary. In FIG. 7A, a thick line represents the boundary. Alternatively, however, the boundary may be colored.

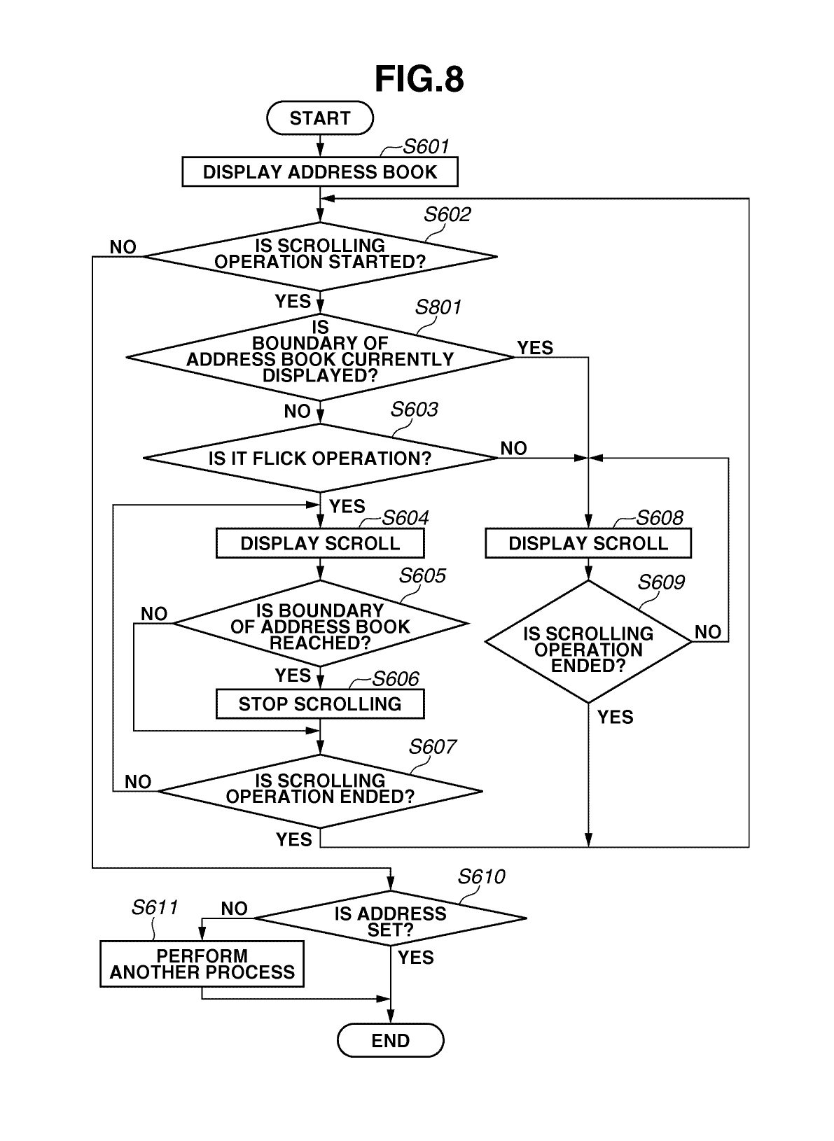

FIG. 8 is a flow chart illustrating an operation of the information processing apparatus 101 according to the present exemplary embodiment. Each step in FIG. 8 is processed when the CPU 111 executes a program stored in the ROM 113 or the external memory 120 of the information processing apparatus 101. FIG. 8 is different from FIG. 6 in that FIG. 8 includes a determination process in step S801.

In step S602, if the CPU 111 determines that the scrolling operation is started (YES in step S602), then the CPU 111 checks in step S801 whether the boundary of the top and the end of the address book is displayed on the display area 712. If the display area 712 does not display the boundary of the top and the end of the address book (NO in step S801), then the CPU 111 advances the process to step S603, performing processing similar to the first exemplary embodiment. On the other hand, if the display area 712 displays the boundary between the top and the end of the address book (YES in S801), then the CPU 111 advances the process to step S609. Similar to the case of the operation in the first exemplary embodiment other than the flick operation, the CPU 111 does not stop scrolling even if the boundary reaches the end of the display area 712.

If the user performs a flick operation when the display area 712 displays the boundary between the top and the end of the address book, then the CPU 111 interprets the flick as a scrolling operation performed to search for address data outside the display area 712. In this case, if the CPU 111 surely stops the scrolling at the boundary, the operability may decrease for the user. The present exemplary embodiment can prevent decrease of the user's operability caused by stop of the scrolling at the boundary between the top and the end of the address book even when a flick operation is started in a state that the display area 712 displays the boundary.

Next, a third exemplary embodiment will be described. The third exemplary embodiment takes the flick speed and the number of address data in the address book into consideration to determine whether the scrolling is stopped at the boundary between the top and the end of the address book. Hereinafter, the third exemplary embodiment will be described, focusing its difference from the first and second exemplary embodiments.

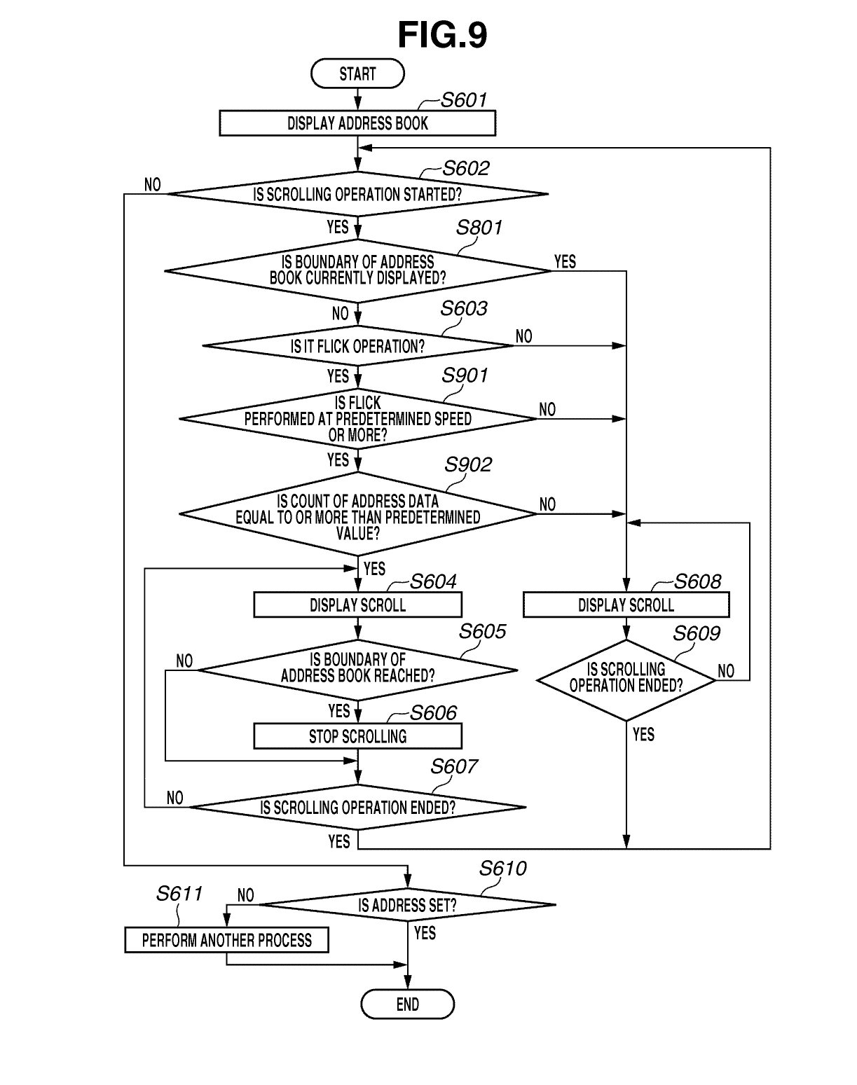

FIG. 9 is a flow chart illustrating an operation of the information processing apparatus 101 according to the present exemplary embodiment. Each step in FIG. 9 is processed when the CPU 111 executes a program stored in the ROM 113 or the external memory 120 of the information processing apparatus 101. FIG. 9 is different from FIG. 8 in that FIG. 9 includes the determination in steps S901 and S902.

In step S603, if the CPU 111 determines that the scrolling operation is caused by the flick operation (YES in step S603), then the CPU 111 detects the speed of scrolling caused by flicking and determines in step S901 whether the detected scrolling speed exceeds a predetermined level (threshold value). Furthermore, the scrolling speed in the scrolling caused by the flick operation varies in accordance with the degree of flicking (the strength, speed, or the like of flicking with the finger). In step S901, if the CPU 111 determines that the scrolling speed exceeds the predetermined level (YES in step S901), then the CPU 111 advances the process to step S902. If the CPU 111 determines that the scrolling speed is slower than the predetermined level (NO in step S901), then the CPU 111 advances the process to step S609.

In step S902, the CPU 111 counts the number of address data included in the address book, and determines whether the counted number is larger than a predetermined value (threshold). If the CPU 111 determines that the number is larger than the predetermined value (YES in step S902), then the CPU 111 advances the process to step S604. If the CPU 111 determines that the number is smaller than the predetermined value (NO in step S902), then the CPU 111 advances the process to step S609.

In the case that scrolling by flicking is not performed at a high speed or the total number of address data is no so many, the CPU 111 does not stop the scrolling at the boundary between the top and the end of the address book.

The operability decreases when the scrolling is surely stopped at the boundary between the top and the end of the address book. However, according to the present exemplary embodiment, such decrease of operability for the user does not occur

Alternatively, the CPU 111 may perform only one determination in either step S901 or S902. Other exemplary embodiments

While the present invention has been described with reference to preferred exemplary embodiments, it is to be understood that the invention is not limited to these specified exemplary embodiments. The intention is to cover various embodiments falling within the spirit and scope of the invention. Some of the above exemplary embodiments may be combined as deemed appropriate.

For example, according to each of the above exemplary embodiments, the scrolling is stopped at the boundary between the top data and the end data of the address book. However, another portion may be used as a boundary.

For example, the boundary may be fixed between address data displayed on the first line of the display area and its previous address data at the time of starting a flick operation. Likewise, the boundary may be fixed between address data displayed on the last line of the display area and address data subsequent thereto at the time of starting a flick operation. More generally, the number of address data displayable on the display area is set to “N” (“N” is an integer of 2 or more), and the address data displayed on the top line of the display area at the time of starting the flick operation is the “M”th data (“M” is an integer). In this case, the boundary can be set between the “(M−1)”th data and the “M”th data or between the (M+N−1)th data and the (M+N)th data. In this manner, a user can be notified that the display has returned to the address data by the cyclic scrolling, which was displayed at the time of starting the flick operation.

Alternatively, the user himself or herself may set the boundary in advance. For example, the user may set the boundary between the address data frequently used by the user, and the previous or subsequent address data. In this case, the user can search for the address data by a high-speed flick operation.

Each of the above exemplary embodiments has been described with respect to one boundary. Alternatively, two or more boundaries may be set. For example, the boundaries may be set between an “A” column and a “KA” column, or between a “KA” column and a “SA” column when Japanese characters are used. Alternatively, the boundaries may be set between the alphabet letters (e.g., between A and B, or between B and C). Alternatively, all of the above examples may be set as the boundaries.

Furthermore, when scrolling is stopped at the boundary, an indication may be given so that the user can recognize that the boundary has been reached. For example, instead of stopping scrolling immediately when the top data of the address book reaches the top line of the display area of the address book by a downward flick operation as illustrated in FIG. 3, the scrolling can be performed until all or part of the end data is once displayed at the top line of the display data. Then, the user may scroll backward by movement like bounce back, and then scrolling may be stopped as shown in FIG. 3B.

According to display control of each of the above exemplary embodiments, it is determined whether or not scrolling is stopped at the boundary depending on whether the operation is a flick operation or any of other operations. However, the above exemplary embodiments may be applied to other applications. More specifically, it may be determined whether or not scrolling is stopped at the boundary depending only on whether an operation for scrolling is a specific operation, and any operation method can be chosen as the specific operation.

For example, in the case of both a flick operation and an operation with scroll button, scrolling may be stopped at the boundary, while in the case of a drag operation and an operation using a scroll bar, scrolling is not stopped at the boundary.

Furthermore, all of four operations employed in the above exemplary embodiments may be specific operation methods. Alternatively, operations other than these four operations may be included in the specific operation methods as long as scrolling can be instructed based on such method. In such a case, processes in steps S603, S608, and S609 can be omitted. However, an operation in which the speed of scrolling is difficult to adjust, should preferably be the specific operation as in the case of the flick operation.

Furthermore, each of the above exemplary embodiments has been described with reference to the scrolling operation by flicking the list of address data in the address book, as an example. However, the present invention is not limited to the list of addresses, and is applicable to a scrolling operation for various contents that can be displayed. For example, the present invention is applicable to any contents, such as telephone number data included in a telephone directory and image data included in an image album, as long as they can be displayed in list form. Furthermore, the scrolling direction in the present invention is not only limited to the upward direction but also applicable to every direction.

Furthermore, each of the above exemplary embodiments has been described with respect to the case in which scrolling is stopped at the boundary. Alternatively, scrolling may be decelerated instead of stopped. Furthermore, the stop and deceleration of the scrolling may be performed in combination. For example, in the case of a flick operation, the scrolling may be stopped at the boundary. In the case of using a scroll button and a scroll bar, the speed of scrolling may be slowed down.

Examples of the above information processing apparatus 101 include various apparatuses such as computers, personal digital assistants (PDAs), cellular phone terminals, printers, scanners, facsimile machines (FAXs), copying machines, cameras, video cameras, and other image viewers. The above exemplary embodiments allow a user to easily recognize the boundaries of a plurality of contents when displaying these contents by cyclically scrolling.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)N, a flash memory device, a memory card, and the like.

According to the exemplary embodiments of the present invention, in the case where a plurality of the contents is cyclically scrolled, a user can easily recognize a boundary of the contents.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-257556 filed Nov. 26, 2012, which is hereby incorporated by reference herein in its entirety.

What is claimed is:

1. An information processing apparatus, comprising:
a display unit configured to display a part of a plurality of contents on a predetermined display area;
a detection unit configured to detect an user operation on a touch panel for scrolling the contents displayed on the display area; and
a display control unit configured to cyclically scroll the contents displayed on the display area in response to the detection by the detection unit, wherein
the display control unit controls the scrolling to enable a user to recognize a boundary of the plurality of contents when the boundary of the plurality of contents has been scrolled up to a border of the display area.

2. The information processing apparatus according to claim 1, wherein
the display control unit is configured to stop or decelerate the scrolling when the boundary of the plurality of contents has been scrolled up to an end of the display area.

3. The information processing apparatus according to claim 2, further comprising:
a determination unit configured to determine whether the user operation detected by the detection unit is a specific operation, wherein
the display control unit is configured to determine whether the scrolling is stopped or decelerated when the boundary of the plurality of contents has been scrolled up to the end of the display area, based on the determination of the determination unit.

4. The information processing apparatus according to claim 3, wherein
the specific operation is a flick operation.

5. The information processing apparatus according to claim 3, wherein
operations other than the specific operation include at least one of a drag operation, an operation for moving a scroll bar, and an operation for pushing down a scroll button.

6. The information processing apparatus according to claim 2, further including:
a confirmation unit configured to confirm whether the boundary of the plurality of contents is displayed on the display area when the detection unit detects the user operation, wherein
when the confirmation unit confirms that the display area displays the boundary of the plurality of contents, the display control unit does not stop or decelerate scrolling even when the boundary of the plurality of contents has been scrolled up to the end of the display area.

7. The information processing apparatus according to claim 2, further comprising:
a detection unit configured to detect a scrolling speed of the contents displayed on the display area, wherein
when the speed of scrolling detected by the detection unit is less than a threshold, the display control unit does not stop or decelerate scrolling even when the boundary of the plurality of contents has been scrolled up to the end of the display area.

8. The information processing apparatus according to claim 2, wherein
when a total number of the contents is less than a threshold, the display control unit does not stop or decelerate scrolling even when the boundary of the plurality of contents has been scrolled up to the end of the display area.

9. The information processing apparatus according to claim 1, wherein
the boundary of the plurality of contents includes at least a portion between top data and end data of the plurality of contents.

10. The information processing apparatus according to claim 9, wherein
the display control unit stops or decelerates scrolling when the top data has been scrolled up to a top line of the display area or the end data has been scrolled up to the end line of the display area.

11. The information processing apparatus according to claim 1, wherein
the display area can display “N” contents on the display area;
the boundary of the plurality of contents includes at least one of a portion between “M”th content displayed on a top line of the display area and “(M−1)”th content, and a portion between “(M+N)”th content and “(M+N−1)”th content when the detection unit detects the user operation.

12. The information processing apparatus according to claim 1, further comprising:
a transmission unit configured to transmit data, wherein
the contents are information about a destination address of data to be transmitted by the transmission unit.

13. A display apparatus, comprising:
a unit configured to display a part of a plurality of contents on a predetermined display area;
a unit configured to detect a user operation on a touch panel for scrolling the contents displayed on the display area;
a unit configured to cyclically scroll the contents displayed on the display area when the user operation is detected; and
a unit configured to control scrolling to recognize a boundary of the plurality of contents when the boundary of the plurality of contents has been scrolled up to an end of the display area.

14. A method for controlling an information processing apparatus, comprising:
displaying a part of contents among a plurality of contents on a predetermined display area;
detecting a user operation on a touch panel for scrolling the contents displayed on the display area;
performing a display control to cyclically scroll the contents displayed on the display area in response to the detection, wherein
in the display control, the scrolling is controlled to enable recognition of a boundary of the plurality of contents when the boundary of the plurality of contents has been scrolled up to an end of the display area.

15. A computer-readable storage medium storing a computer program for causing a computer to execute the control method according to claim 14.
